(19) United States
(12) Patent Application Publication
(10) Pub. No.: US 2026/0119687 A1
(43) Pub. Date: Apr. 30, 2026

(54) DEVICE FOR PROTECTING DATA AND METHOD FOR PROTECTING DATA

(71) Applicant: Renesas Electronics Corporation, Tokyo (JP)

(72) Inventors: Christian MARDMOLLER, Dusseldorf (DE); Tobias BELITZ, Dusseldorf (DE)

(21) Appl. No.: 19/342,122

(22) Filed: Sep. 26, 2025

(30) Foreign Application Priority Data
Oct. 30, 2024 (DE) 10 2024 131 700.0

(51) Int. Cl. G06F 21/62; H04L 9/08

(52) U.S. Cl. CPC G06F 21/6209; H04L 9/0819

(57) ABSTRACT

Apparatus and method for protecting data frames at a transmission side of a frame-based communication link are described. The apparatus includes a cipher suite module. The cipher suite model receives the data frame and protects the data frame based on a first cryptographic key if the data frame is a priority data frame and protects the data frame based on a second cryptographic key if the data frame is a non-priority data frame. The non-priority data frame is a data frame for which transmission can be interrupted by a data frame that is the priority data frame. After protecting the data frame, the cipher suite module provides the protected data frame for transmission over the frame-based communication link.

### CROSS-REFERENCE TO RELATED APPLICATIONS

The disclosure of German Patent Application No. 10 2024 131 700.0 filed on Oct. 30, 2024, including the specification, drawings and abstract is incorporated herein by reference in its entirety.

### BACKGROUND

The present disclosure relates to frame-based communication and more particular to a combination of security and preemption techniques for frame-based communication.

For frame-based communication, security as well as latency need to be considered individually or in combination, depending on the use case. However, security and latency requirements may contradict each other, or it may be difficult to fulfill both requirements at the same time.

For example, for Ethernet, security on the data link level is provided by Ethernet Media Access Control Security (MACsec).

### MACsec

MACsec is a security protocol designed to provide secure communication over Ethernet networks by protecting data at the data link layer (Layer 2). Defined in the IEEE 802.1AE and IEEE 802.1X standard, MACsec offers critical features such as data confidentiality, integrity, and authentication. It ensures that communication between directly connected apparatus, like switches, routers, and end-user apparatus, is protected from various threats, including unauthorized access, eavesdropping, replay attacks, and data tampering.

MACsec operates by encrypting and authenticating Ethernet frames using cryptographic techniques, preventing attackers from intercepting or altering the data being transmitted. It supports point-to-point encryption, meaning it secures data on a hop-by-hop basis across network apparatus, making it ideal for Local Area Networks (LANs), data center environments, enterprise networks, industrial environments and automotive environments.

Specifically, MACsec prevents replay attacks by incorporating a packet numbering mechanism and a replay protection window into its security architecture.

On the transmission side, every Ethernet frame using MACsec is assigned a unique sequence number called a Packet Number (PN). This number increments with each frame sent from a given node.

The PN is included in the frame's security tag (SecTAG), which is part of the MACsec header. Since the PN is unique and always increasing, it ensures that each transmitted frame can be uniquely identified by the receiver.

Further, the receiving apparatus maintains a sliding window of acceptable PNs for incoming frames. If a frame arrives with a PN that is outside this window—meaning it's either too old or has already been processed—the frame is discarded. This ensures that frames replayed or delayed by an attacker are rejected, as their PNs would fall outside the expected range. To achieve full replay protection, the windows size may be set to zero. In other words, data frames are only accepted if they arrive in order, i.e., with ascending PN.

By combining the packet numbering and replay protection window mechanisms, MACsec ensures that only legitimate, fresh frames are accepted, effectively preventing an attacker from capturing and replaying old frames to disrupt communication or impersonate a legitimate sender.

Further, two key concepts in MACsec are used to protect data frames, namely Secure Channel (SC) and Secure Association (SA).

An SC is a logical connection established between two or more MACsec-enabled apparatus, typically peers like switches or hosts, over which secure communication occurs. The SC forms the foundation of MACsec's security model by ensuring that all communication between apparatus is protected under the same security policy. Within an SC, Ethernet frames are protected using encryption and integrity checks, making eavesdropping or tampering difficult.

A single SC can have multiple SAs, which manage the actual cryptographic operations. Therefore, a SA is responsible for the cryptographic parameters (like encryption keys and algorithms) used within a SC to protect Ethernet frames.

For simplicity, it will mostly be referred to SCs in the following description, even if the functionality is related to SAs.

### Preemption

Further, for fulfilling certain latency requirements, Ethernet preemption has been introduced.

Ethernet preemption is a technology defined in the IEEE 802.1Q-2022 standard, designed to improve the efficiency and predictability of Ethernet networks, particularly in time-sensitive applications. Ethernet preemption enables a high-priority frame to interrupt the transmission of a lower-priority frame, allowing the urgent data to be transmitted with minimal delay. Once the high-priority transmission is completed, the lower-priority frame resumes from where it was paused, ensuring that no data is lost during the preemption process.

This feature is essential for applications requiring low-latency communication, such as industrial automation, autonomous vehicles, telecommunications, and real-time control systems. In such environments, even slight delays in transmitting time-sensitive data can lead to performance degradation, safety concerns, or failure of critical systems.

Ethernet preemption works by dynamically splitting large frames into smaller, preemptible fragments, allowing higher-priority frames to be transmitted in between. It ensures that critical traffic, such as control signals or real-time data streams, can bypass large, non-urgent frames without having to wait for their transmission to complete. This improves the overall quality of service (QoS) and reduces jitter, enhancing the network's ability to handle mixed traffic loads.

### Combination of MACsec and Preemption

A combination of MACsec and preemption may however lead to the following problem. Preemption relies on reordering the frames, i.e., due to priority frames, frames will not arrive in the expected order at the receiver (expected PN). Therefore, MACsec and preemption can only be combined when the MACsec PN window is relaxed such that out of order packets are accepted. Relaxing the MACsec PN window however opens up the Ethernet system to replay attacks, contradicting the functionality of MACsec. A combination of MACsec and preemption may be improved by using multiple SCs and trying to protect the different data frames (express and preemption data frames) with a different SC. Currently, however, MACsec does not receive any information whether a to be protected data frame is an express or preemption data frame. In other words, for a current MACsec implementation, an express data frame and a preemption data frame may not be directly distinguishable. Therefore, the SC used for protection of a data frame may be chosen based on information in the data frame, e.g., by filtering for MAC and VLAN information in the data frame.

Thus, there is a need for providing an efficient implementation of MACsec and preemption in an ethernet system, enabling security and latency requirements at the same time.

### SUMMARY

In view of the above, the present disclosure provides methods and apparatus for improving security for a frame-based communication link with priority frames, by adapting the transmission side or the receiving side of the frame-based communication link.

According to a first aspect of the disclosure, an apparatus for protecting a data frame for a frame-based communication link is disclosed. The apparatus may include a cipher suite module. The cipher suite module may be configured to protect the data frame based on a first cryptographic key if the data frame is a priority data frame and protect the data frame based on a second cryptographic key if the data frame is a non-priority data frame. The non-priority data frame may be a data frame for which transmission can be interrupted by a data frame that is the priority data frame. Protecting the data frame may include adding an integrity value to the data frame using the data frame and the respective cryptographic key, i.e., the first cryptographic key for the priority data frame and the second cryptographic key for the non-priority data frame. Protecting the data frame may further include encrypting the data frame based on the respective cryptographic key. Encrypting the data frame may include encrypting a data part of the data frame. The cipher suite module may be further configured to provide the protected data frame for transmission over the frame-based communication link.

By using different cryptographic keys for priority and non-priority data frames, a transmitter may be able to process priority and non-priority data frames independently without any knowledge whether the data frame is apriority and non-priority data frame. Thereby, security and the principle of priority frames can be combined by only adapting a transmission side of a frame-based communication link.

In some embodiments, the frame-based communication link may be a wired communication link. In particular, the frame-based communication link may be an Ethernet communication link and the apparatus may be a Media Access Control Security, MACsec apparatus of a transmission Ethernet side. Therefore, the data frame may be an Ethernet data frame, the priority data frame may be an express data frame and the non-priority data frame may be a preemption data frame. The first cryptographic key may belong to a first Security Channel, SC, and the second cryptographic key belongs to a second SC. Further, the first cryptographic key may be a cryptographic key of a first Security Association, SA, in the first SC and the second cryptographic key may be a cryptographic key of a second SA in the second SC.

In some embodiments, the apparatus may receive the date data frames from a transmission queue of a transmission side of the frame-based communication link.

In some embodiments, the apparatus may further include a classification module and an SC configuration module. The classification module may receive priority information of the data frame from the transmission queue (i.e., not from the data frame but the transmission queue itself) and classify the data frame based on the priority information as a priority data frame or a non-priority data frame. The classification module may provide the classification result to the SC configuration module and the SC configuration module may select an SC based on the classification result and may provide the SC to the cipher suite module for protecting the data frame.

In some embodiments, the protected data frame may be provided to an Ethernet MAC module. The apparatus may include the Ethernet MAC module or the Ethernet MAC module may be connected to the apparatus.

According to a second aspect of the disclosure, an apparatus for verifying a data frame ordering for a frame-based communication link is provided. The apparatus may include a packet number handling module. The packet number handling module may receive priority information of a received data frame. The priority information may indicate whether the received data frame is a priority data frame or a non-priority data frame. The non-priority data frame may be a data frame for which transmission can be interrupted by a data frame that is the priority data frame. The packet number handling module may further receive a packet number of the received data frame. The packet number handling may compare the packet number to a priority packet counter and a common packet counter, if the priority information indicates that the received data frame is a priority frame. Based on the comparison the priority packet counter and the common packet counter may be maintained or updated or the discarding of the received data frame may be ordered. The packet number handling module may compare the packet number to a non-priority packet counter, to the priority packet counter and to the common packet counter, if the priority information indicates that the received data frame is a non-priority frame. Based on the comparison, the priority packet counter, the non-priority packet counter and the common packet counter are maintained or updated or the discarding of the received data frame is ordered.

By implementing the three distinct counters, protection against most data frame resend attacks may be achieved. Thereby security and the principle of priority frames can be combined by only adapting a receiving side of a frame-based communication link.

In some embodiments, the frame-based communication link may be a wired communication link. In particular, the frame-based communication link may be an Ethernet communication link and the apparatus may be a Media Access Control Security, MACsec apparatus of a receiving Ethernet side. Therefore, the data frame may be an Ethernet data frame, the priority data frame may be an express data frame and the non-priority data frame may be a preemption data frame.

In some embodiments, comparing the packet number to a priority packet counter and a common packet counter (i.e., if the priority information indicates that the received data frame is a priority frame); and based on the comparison, maintaining or updating the priority packet counter and the common packet counter or ordering to discard the received data frame may include updating the priority packet counter and the common packet counter, if the packet number is equal or greater than the priority packet counter and the common packet counter. It may further include maintaining the priority packet counter and the common packet counter and ordering to discard the received data frame, if the packet number is lower than a lowest packet number of a priority window, starting at the priority packet counter and extending in descending direction, or lower than a lowest packet number of a common window, starting at the common packet counter and extending in descending direction.

Further, comparing the packet number to a non-priority packet counter, the priority packet counter and to the common packet counter (i.e., if the priority information indicates that the received data frame is a non-priority frame), and based on the comparison, maintaining or updating the priority packet counter, the non-priority packet counter and the common packet counter or ordering to discard the received data frame may include updating the priority packet counter, the non-priority packet counter or the common packet counter, if the packet number is equal or greater than the non-priority packet counter, the common packet counter or the priority packet counter. It may further include maintaining the priority packet counter, the non-priority packet counter and the common packet counter and ordering to discard the received data frame, if the packet number is lower than a lowest packet number of a non-priority window, starting at the non-priority packet counter and extending in descending direction or lower than a lowest packet number of the common window. A size of the priority window and the non-priority window may be zero, and a size of the common window may be larger than zero. The size of the priority window and the non-priority window may be zero independently of a size of the common window, as priority data frames and non-priority data frames can only arrive in order when viewed separately.

In some embodiments, the packet number handling module may receive the priority information from an Ethernet MAC module. The apparatus may include the Ethernet MAC module or the Ethernet MAC module is connected to the apparatus.

In some embodiments, the apparatus may further include a decryption module. The decryption module may be configured to authenticate and optionally decrypt the received data frame when the received data frame is not discarded. The received data frame may be received from the Ethernet MAC module and decrypting the received data frame may be based on a pre-negotiated security association, SC. The pre-negotiated SC may have been negotiated based on a MACsec Key Agreement, MKA with an Ethernet transmission side. The pre-negotiated SC may consist of a single SC or the pre-negotiated SC may include multiple SCs, but only one SC may use the combination of the priority packet counter, the non-priority packet counter and the common packet counter. The decryption module may transmit the authenticated and optionally decrypted received data frame to a receiving queue of the frame-based communication link.

According to a third aspect of the disclosure, a method for protecting a data frame for a frame-based communication link is disclosed. The method may implement the functionalities defined according to any variation of the first aspect.

According to a fourth aspect of the disclosure, a method for verifying a data frame ordering for a frame-based communication link is provided. The method may implement the functionalities defined according to any variation of the second aspect.

In some embodiments, the method according to the third aspect may be used in addition to the method for verifying a data frame ordering for a frame-based communication link.

According to a fifth aspect, a system for a frame-based communication link is provided. The system includes the apparatus according to any variation of the first aspect on the transmission side of the frame-based communication link and the apparatus according to any variation of the second aspect on the receiving side of the frame-based communication link.

It will be appreciated that apparatus features and method steps may be interchanged in many ways. In particular, the details of the disclosed method(s) can be realized by the corresponding apparatus (or system), and vice versa, as the skilled person will appreciate. Moreover, any of the above statements made with respect to the method(s) are understood to likewise apply to the corresponding apparatus (or system), and vice versa.

### BRIEF DESCRIPTION OF DRAWINGS

FIG. 1 schematically illustrates possible replay attacks for Ethernet preemption in the prior art and according to embodiments of the disclosure,

FIG. 2 schematically illustrates an apparatus for protecting frames at a transmission side of a frame-based communication link according to embodiments of the disclosure,

FIG. 3 schematically illustrates an apparatus for protecting frames at a transmission side of an Ethernet system according to embodiments of the disclosure,

FIG. 4 schematically illustrates an apparatus for verifying a data frame ordering for a frame-based communication link according to embodiments of the disclosure,

FIG. 5 schematically an apparatus for verifying a data frame ordering for an Ethernet system according to embodiments of the disclosure,

FIG. 6 is a flowchart illustrating an example process by a packet handling module if a data frame is an express data frame according to embodiments of the disclosure,

FIG. 7 is a flowchart illustrating an example process by a packet handling module if a data frame is a preemption data frame according to embodiments of the disclosure,

FIG. 8 schematically illustrates packet number windows for verifying a data frame ordering according to embodiments of the disclosure,

FIG. 9 is a flowchart illustrating an example of a method of protecting frames at a transmission side of a frame-based communication link according to embodiments of the disclosure,

FIG. 10 is a flowchart illustrating an example of a method of verifying a data frame ordering for a frame-based communication link according to embodiments of the disclosure.

### DETAILED DESCRIPTION

As mentioned in the background section, MACsec defines a PN window such that only packets with a packet number inside the PN window are accepted at the receiver. For full replay attack protection, the window size is set to 0, i.e., the packets have to arrive at the receiver in the same order as they were sent by the transmitter. This may be a typical setting for MACsec in automotive Ethernet networks.

To use preemption, the window size must be larger than 0, as preemption intrinsically relies on the reordering of frames such that priority frames can be transmitted with a lower latency. This however is detrimental to the security of the Ethernet system as replay attacks become possible. The following attacks may generally be possible with a PN window size greater than 0:
Delay of a frame, suppression of a frame, resending of a frame
When a priority frame is denoted as an eMAC frame and a preemption frame is denoted as a pMAC frame, the following four different resend attacks may be defined:
   Resend eMAC frame as eMAC frame (e/e)
   Resend pMAC frame as pMAC frame (p/p)
   Resend eMAC frame as pMAC frame (e/p)
   Resend pMAC frame as eMAC frame (p/e)

For an SC a Secure Association Key (SAK) is used to encrypt and authenticate data between MACsec peers. The SAK is shared between apparatus through a secure key exchange mechanism such as 802.1X with EAP (Extensible Authentication Protocol) or other key distribution methods (like MKA—MACsec Key Agreement protocol).

In MACsec, typically a single SC is used for secure communication between two Ethernet sides for a certain time period.

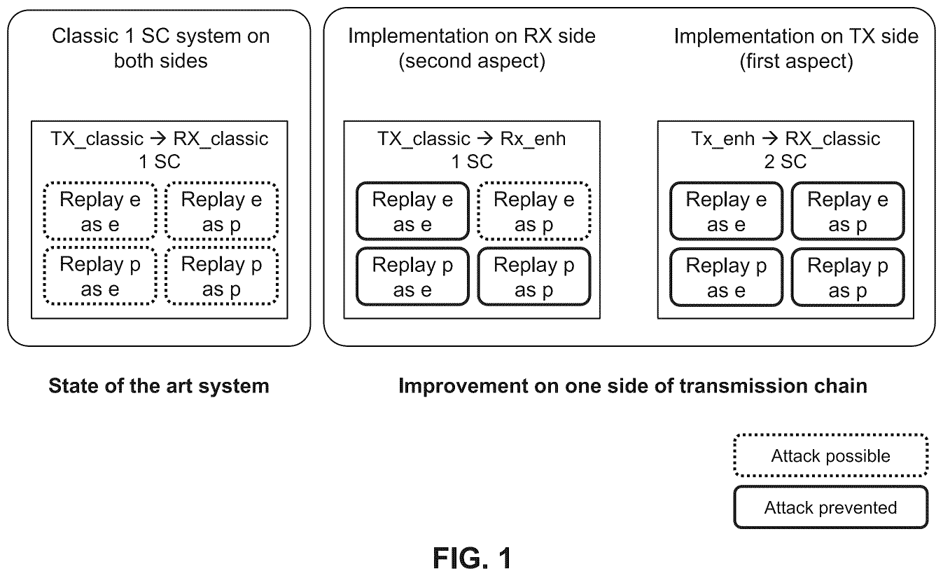

For a combination of a single SC and enabling preemption for an Ethernet link, the system is vulnerable to all four resend attacks mentioned above. This scenario is depicted on the left side in FIG. 1.

To enable security and preemption at the same time, an efficient implementation of said aspects is proposed for the transmitting side as well as for the receiving side. In particular, for an implementation at the receiving side and no adaption of the transmitter side (second aspect), three out of four resend attacks can be prevented. Further, with an implementation at the transmitting side and no adaption at the receiving side (first aspect), all resend attacks can be prevented. These scenarios are depicted on the right side of FIG. 1. Therefore, even if only the hardware at a transmit side or a receiver side can be updated, full or close to full protection against resend attacks can be achieved.

The figures (FIGs.) and the following description relate to preferred embodiments by way of illustration only. It should be noted that from the following discussion, alternative embodiments of the structures and methods disclosed herein will be readily recognized as viable alternatives that may be employed without departing from the principles of what is claimed.

Reference will now be made in detail to several embodiments, examples of which are illustrated in the accompanying figures. It is noted that wherever practicable similar or like reference numbers may be used in the figures and may indicate similar or like functionality. The figures depict embodiments of the disclosed system (or method) for purposes of illustration only. One skilled in the art will readily recognize from the following description that alternative embodiments of the structures and methods illustrated herein may be employed without departing from the principles described herein.

While the invention for the transmitting side and the receiving side of a frame-based communication link will be mostly presented with reference to the Ethernet standard, it is noted that the invention can be implemented for any frame-based method with a layer 2 security system, based on a secure key and packet numbers, and supporting the concept of priority frames.

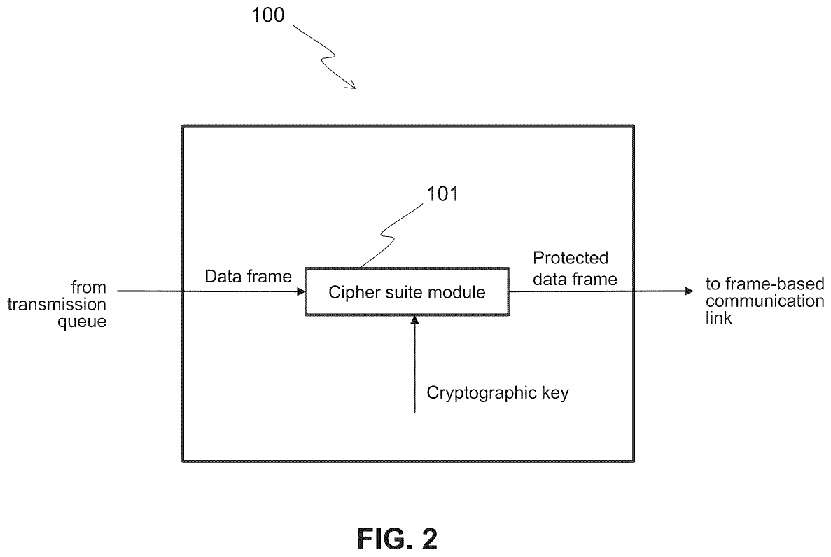

FIG. 2 schematically illustrates an apparatus 100 for protecting frames at a transmission side of a frame-based communication link.

Apparatus 100 comprises cipher suite module 101 for protecting data frames. The cipher suite module 101 receives data frames, wherein the data frames are intended to be transmitted over the frame-based transmission link. A data frame may either be a priority data frame or non-priority data frame. A priority data frame is a data frame for which transmission of a non-priority data frame can be interrupted. In other words, when a priority data frame is to be transmitted over the frame-based communication link, transmission of a current non-priority data frame is interrupted, until transmission of the priority data frame is completed. Cipher suite module 101 then uses two different cryptographic keys to protect the data frames, i.e., a first cryptographic key to protect a priority data frame and a second cryptographic key to protect the non-priority data frame. Protecting the data frame may include generating an integrity value based on the content of the data frame and the cryptographic key. The integrity value may then be added to the data frame by cipher suite module 101 to generate a protected data frame. The integrity value may enable a receiving side to authenticate whether the content of the data frame has been altered, by generating a second integrity value based on the content of the data frame and the same cryptographic key that has been used at the transmission side, and by comparing the integrity value included in the data frame to the generated second integrity value.

Protecting the data frame may further comprise encrypting the data frame based on the cryptographic key. More precisely, a payload of the data frame may be encrypted.

By using two distinct cryptographic keys for protecting the different types of data frames, i.e., priority data frames and non-priority data frames, a security system at a receiving side can handle priority data frames and non-priority data frame independently even if the security side has no information whether a received data frame is a priority data frame or a non-priority data frame. In other words, a receiver does not need to be adapted for the combination of security and priority frames, as priority data frames and non-priority data frames can be handled independently.

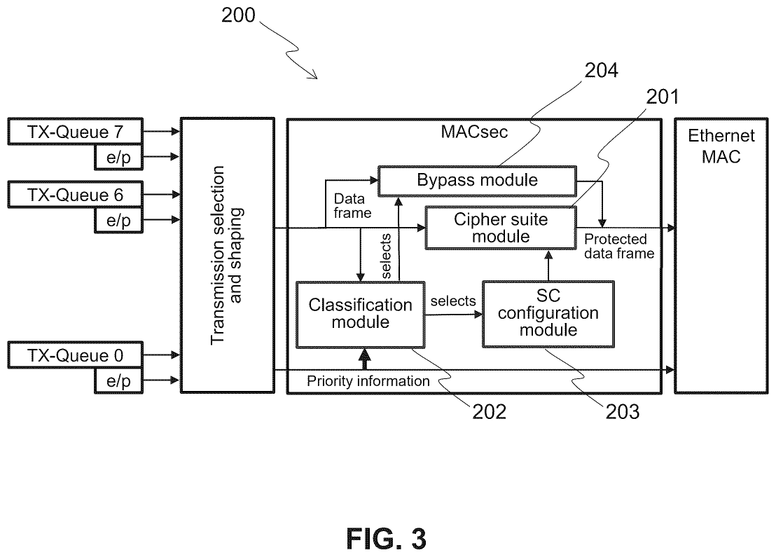

Next, in FIG. 3, apparatus 200 is shown, which may be an implementation of apparatus 100 in an Ethernet system. Therefore, apparatus 200 may be a MACsec apparatus, i.e., an apparatus in the Ethernet communication chain that implements the MACsec standard. Apparatus 200 may comprise cipher suite module 201. Cipher suite module 201 may be an implementation of cipher suite module 101, i.e., it provides the same functionality. For MACsec apparatus 200, the data frame may therefore be an Ethernet data frame and the priority data frame may be an express data frame and the non-priority data frame may be a preemption data frame.

As mentioned in the background section, MACsec implements secure communication between two or more endpoints by establishing an SC and by protecting data frames based on the SAK. MACsec generally provides the option for using multiple different SCs for the same ethernet link, for example for periodically cycling between different SCs. In a current MACsec implementation however, the selection of the SC has no knowledge about whether a frame is an express frame or preemption frame. Therefore, apparatus 200 is provided with said information (priority information) to enable SC selection based on the different data frame types. In particular, an Ethernet transmission side may comprise one or more transmission queues (TX-Queue). The one or more transmission queues may forward the priority information to MACsec apparatus 200. MACsec apparatus 200 may further comprise classification module 202, which receives the priority information. Based on the content of the priority information, i.e., whether a current frame is an express data frame or a preemption data frame, classification module 202 may provide a selection instruction for SC configuration module 203. Based on the selection instruction SC configuration module 203 may either provide a first SAK, corresponding to the first cryptographic key, or a second SAK, corresponding to the second cryptographic key, to cipher suite module 201. Thereby SCs selection for express data frames and for preemption data frames may be implemented efficiently.

MACsec apparatus 204 may further comprise bypass module 204, which is configured to provide a bypass to cipher suite module 201, for frames that are not intended to be protected, e.g., key negotiation frames. SC configuration module 203 may provide the instruction for bypassing cipher suite module 201 to bypass module 204.

MACsec apparatus 200 provides the protected data frame to an Ethernet MAC entity for transmission over the Ethernet link, wherein the Ethernet MAC entity may be part of MACsec apparatus 200 or may be part of a separate apparatus connected to MACsec apparatus 200.

Thereby, an efficient combination of secure communication together with the preemption technique can be provided between two or more ethernet sides, without any adaption of the receiver side. This is achieved by automatically switching between the two different SCs based on the provided priority information, i.e., without analyzing the content of data frame. In particular, any existing Ethernet receiver side supporting MACsec with two SCs may be used together with the MACsec apparatus 200. The existing receiver can reliably decode the received data frames merely based on the different SCs, using a PN window of size zero, without any priority information, i.e., whether a received data frame is an express data frame or a preemption data frame.

In the following, an implementation for the opposite side will be presented, i.e., a transmitter side is unchanged, while a receiver side is improved.

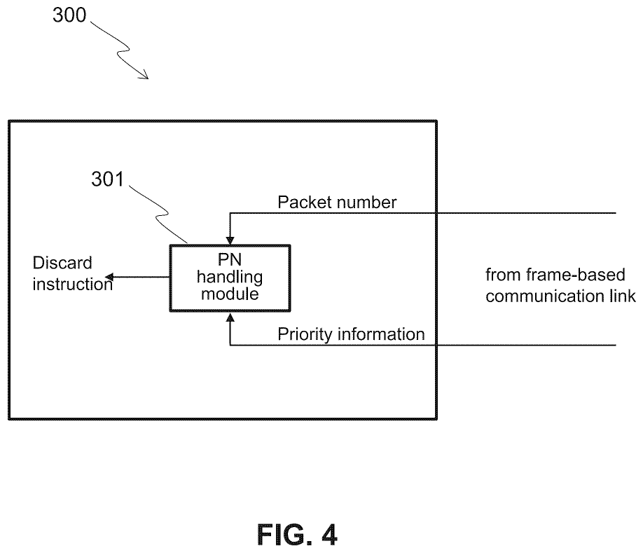

FIG. 4 schematically illustrates an apparatus 300 for verifying a data frame ordering for a frame-based communication link. Therefore, apparatus 300 may be implemented at a receiver side of a frame-based communication link. Apparatus 300 comprises PN handling module 301. PN handling module 301 is configured to receive priority information. The priority information indicates whether a received data frame is a priority data frame or a non-priority data frame. For a definition of the two types of data frames it is referred to FIG. 2. PN handling module 301 further receives a PN of the received data frame. The PN may be included in the data frame and may be extracted by PN handling module or another suitable entity in apparatus 300 (not shown in FIG. 3). To protect the receiving side of the frame-based communication link, PN handling module 301 may use three distinct packet counters, namely, a common packet counter, a priority packet counter and a non-priority packet counter. Based on the received priority information and the received PN, the counters are either maintained, updated or a discard instruction for the received data frame is issued. In particular, if the priority information indicates that the received data frame is a priority data frame, the PN is compared to the common packet counter and the priority packet counter. Based on a result of the comparison, the common packet counter and the priority packet counter may be maintained, updated or a discard instruction may be issued for the received frame. If the priority information indicates that the received data frame is a non-priority data frame, the PN may compared to the common packet counter, the priority packet counter and the non-priority packet counter. Based on the comparison, the common packet counter, the priority packet counter and the non-priority packet counter are maintained, updated or a discard instruction may be issued for the received frame.

Thereby, a receiving side of the frame-based communication link may be protected from three out of four possible resend attacks, in particular, resending a priority data frame, resending a non-priority data frame and resending a non-priority data frame as a priority data frame, even if a transmitting side is left unchanged, i.e., is not adapted for a combination of security and the principle of priority frames.

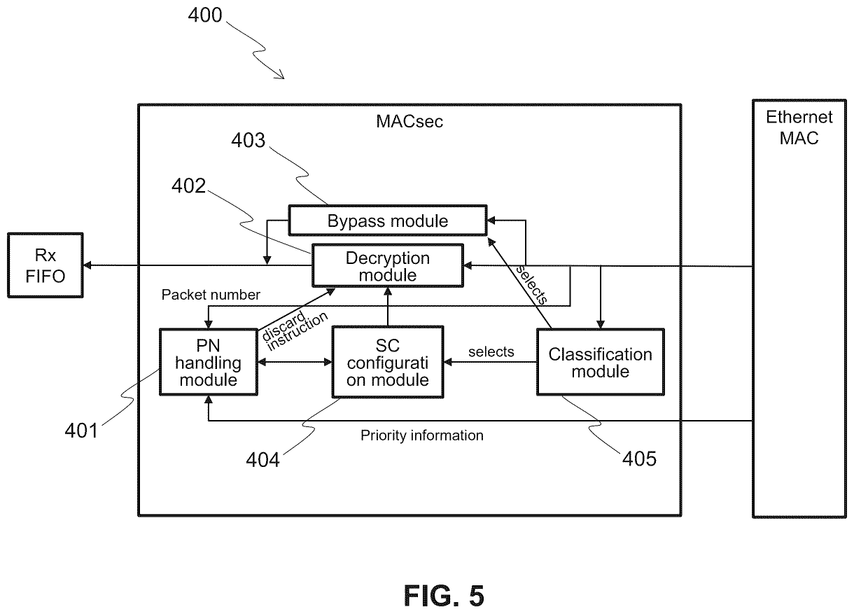

Next, in FIG. 5, apparatus 400 is shown, which may be an implementation of apparatus 300 in an Ethernet system. Therefore, apparatus 400 may be a MACsec apparatus, i.e., an apparatus in the Ethernet communication chain that implements the MACsec standard. Apparatus 400 may comprise PN handling module 401. PN handling module 401 may be an implementation of PN handling module 301, i.e., it provides the same functionality. For MACsec apparatus 400, the data frame may therefore be an Ethernet data frame and the priority data frame may be an express data frame and the non-priority data frame may be a preemption data frame. PN handling module 401 may comprise a plurality of PN handling modules, each for a different SA, if multiple SA may be active at the same time. The three packet counters (priority packet counter, non-priority packet counter and the common packet counter) may be implemented in each of the plurality PN handling modules or only in a single SA, i.e., the other PN handling modules may only use a common packet counter.

In the Ethernet context, maintaining or updating the three different counters (priority packet counter, non-priority packet counter and common packet counter) may include defining three corresponding windows, i.e., a priority window, a non-priority window and a common window. A window may define a range of PNs, starting from the respective counter, for which incoming data frames are accepted. For example, if the common packet counter is equal to a PN=10, and the common window size is 2, all data frames with PNs equal to or greater than 8 are accepted, and for all data frames with a PN below 8, a discard instruction is generated.

After defining the window types, PN handling module 401 may adopt a processing depending on the type of the received data frame.

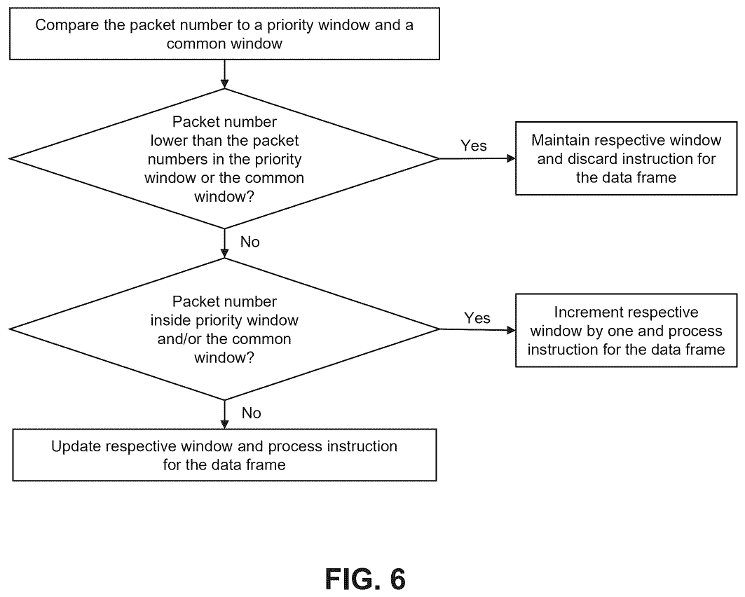

FIG. 6 depicts an example for processing performed PN handling module 401 if the priority information indicates that the received data frame is an express data frame.

In particular, the PN of the received data frame is compared to the priority window and the common window. If the packet number is lower than the packet numbers in the priority window or the common window, i.e., the respective packet number range defined by the priority window and the common window, a discard operation may be issued for the data frame and the windows may be maintained, i.e., the range of packet numbers defined by the windows remains unchanged. Otherwise, an instruction for processing, e.g., decoding, the data frame may be issued by PN handling module 401. Additionally, the respective windows may be maintained or updated depending on the relation of the packet number to the respective packet counters. In particular, if the packet number is lower than the priority packer counter or the common packet counter (it is assumed that the priority packet counter and the common packet counter are synchronized, i.e., have the same value), all windows are maintained, i.e., the packet number range by the windows does not change. Otherwise, i.e., if the packet number is larger than or equal to the packer numbers in the respective counters, the common window and the priority window are updated/shifted, i.e., the new window starts at one number higher than the packet number of the received data frame and extends in descending direction depending on the window size. For example, if a current windows size is 2, the window is defined from 8 to 10 and the received packet number is equal to 100, the new window is defined from 99 to 101.

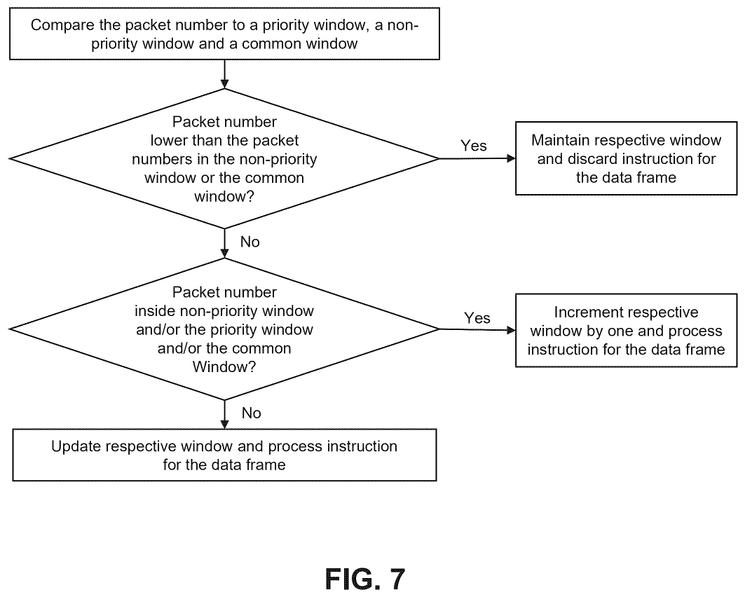

Further, FIG. 7 depicts an example for processing performed PN handling module 401 if the priority information indicates that the received data frame is a preemption data frame. In particular, the PN of the received data frame is compared to the non-priority window, the priority window and the common window. If the packet number is lower than the packet numbers in the non-priority window or the common window, i.e., the respective packet number range defined by the non-priority window and the common window, a discard operation may be issued for the data frame and the windows may be maintained, i.e., the range of packet numbers defined by the windows remains unchanged. Otherwise, an instruction for processing, e.g., decoding, the data frame may be issued by PN handling module 401. Additionally, the respective windows may be maintained or updated depending on the relation of the packet number to the respective window. In particular, if the packet number is lower than a the non-priority packet counter (it is assumed that the priority packet counter and the common packet counter are synchronized and always equal or higher than the non-priority packet counter), all windows are maintained. Further, if the packet number is larger than or equal to the non-priority packet counter but lower than the priority packet counter, the non-priority window is updated, while the priority window and the common window are maintained. Otherwise, i.e., if the packet number is larger than or equal to the priority packet counter, all windows are updated/shifted, i.e., the new window starts at one number higher than the packet number of the received data frame and extends in descending direction depending on the window size. Therefore, not only the non-priority window and the common window may be updated depending on a packet number of a preemption frame, but also the priority window to protect from a preemption specific resending attack, i.e., resending pMAC data frames as eMAC data frames.

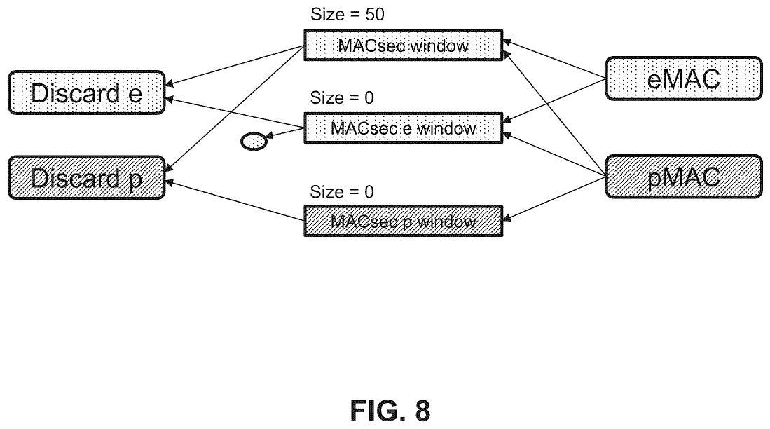

An example for specific window sizes is depicted in FIG. 8. In particular, in a preferred configuration, the priority window (MACsec e window) and non-priority window (MACsec p window) may have a size equal to 0. On the other hand, the common window (MACsec window) may have a size larger than zero. The common window may be identical to the window already used in the MACsec standard. In the example of FIG. 8, the common window may have a size of 50. While updating the common window and the non-priority window is based on both express data frames (eMAC) and preemption data frames (pMAC), updating of the priority window is only based on express data frames. By using a priority window of size 0, protection against an express frame resend attack may be achieved. Further, by using a non-priority window of size 0, protection against a preemption frame resend attack may be achieved. Further, as the priority packet counter is updated, i.e. the priority window is shifted, if a preemption frame has a valid PN, full protection against resending a preemption frame as an express frame is achieved. Only resending an express frame as a preemption frame may still be a possible attack, depending on the common window size. The common window size may therefore be a tradeoff between this resend attack and the flexibility of interrupting a preemption frame, i.e., how many express frames may interrupt a preemption frame.

In summary, while not all possible resend attacks can be prevented, a security of an Ethernet system using both MACsec and preemption is vastly improved without any adaptions of the transmission side.

Returning back to FIG. 5 MACsec apparatus 400 may comprise additional modules which provide a similar or corresponding functionalities as defined for MACsec apparatus 200.

In particular, MACsec apparatus 400 may comprise SC configuration module 404 and decryption module 402.

SC configuration module 404 may provide the SAK to the decryption module 402, such that decryption module 402 can authenticate the received data frame, i.e. based on the integrity data added at the transmitting side, for example by cipher suite module 201. Further, if the received data frame has been encrypted by a transmission side, for example by cipher suite module 201, the received data frame is decrypted based on the corresponding SAK. In a preferred implementation, SC configuration module 404 may operate with a single SAK. This enables operation together with a legacy transmission side, i.e., a transmitting side using a single SAK for protection of both express and preemption data frames. Alternatively, SC configuration module 404 may operate with multiple SAK, i.e., based on an SC setting used by a transmission side of the Ethernet system.

Further, MACsec apparatus 400 may comprise classification module 405 and bypass module 403, providing a similar functionality as classification module 202 and bypass module 204, respectively.

PN handling module 401 may receive the priority information from a MAC entity of the Ethernet communication system, wherein the MAC entity may be part of MACsec apparatus 400 or may be part of a different apparatus connected to MACsec apparatus 400. The PN for PN handling module 401 may be extracted from the received data frame, i.e. the data frame forwarded by the MAC entity. Further, discard instructions from PN handling module 401 may be transmitted to decryption module 402, such that any processing by decryption module 402 for a current received data frame is aborted when the discard instruction is received. Alternatively, the discard instructions are applied after processing the received data frame by decryption module 402, i.e., a received data frame is discarded after decryption module 402.

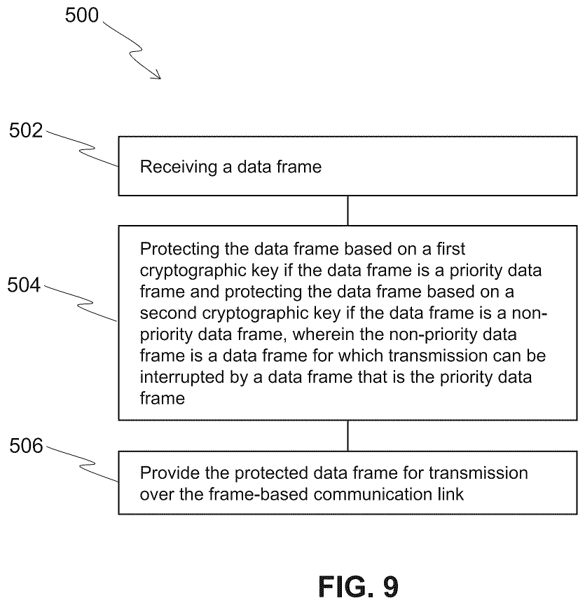

In line with the above, a method 500 is provided for protecting frames at a transmission side of a frame-based communication link as depicted in the flowchart of FIG. 9. In addition to the following method steps, method 500 may optionally include all variations described above with respect to apparatus 100 and 200 that have been described in connection with FIGS. 2 and 3.

In step S502, a data frame is received.

In step S504, the data frame is protected based on a first cryptographic key if the data frame is a priority data frame and the data frame is protected based on a second cryptographic key if the data frame is a non-priority data frame, wherein the non-priority data frame is a data frame for which transmission can be interrupted by a data frame that is the priority data frame.

In step S506, the protected data frame is provided for transmission over the frame-based communication link.

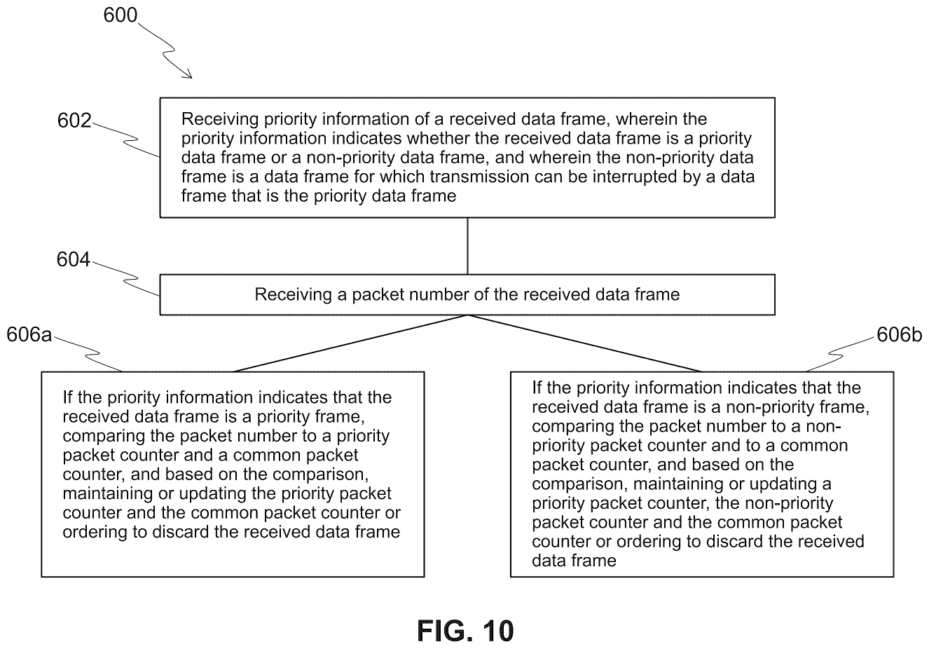

Further, a method 600 is provided for verifying a data frame ordering for a frame-based communication link as depicted in the flowchart of FIG. 10. In addition to the following method steps, method 500 may optionally include all variations described above with respect to apparatus 300 and 400 that have been described in connection with FIGS. 4 to 8.

In step S602, priority information of a received data frame is received, wherein the priority information indicates whether the received data frame is a priority data frame or a non-priority data frame, and wherein the non-priority data frame is a data frame for which transmission can be interrupted by a data frame that is the priority data frame.

In step S604, a packet number of the received data frame is received.

In step S606a, the packet number is compared to a priority packet counter and a common packet counter, if the priority information indicates that the received data frame is a priority frame, and based on the comparison, the priority packet counter and the common packet counter are maintained or updated, or discarding the received data frame is ordered.

In step S606b, the packet number is compared to a non-priority packet counter, a priority packet counter and to a common packet counter, if the priority information indicates that the received data frame is a non-priority frame, and based on the comparison, a priority packet counter, the non-priority packet counter and the common packet counter are maintained or updated, or discarding the received data frame is ordered.

While one or more implementations have been described by way of example and in terms of the specific embodiments, it is to be understood that one or more implementations are not limited to the disclosed embodiments. To the contrary, it is intended to cover various modifications and similar arrangements as would be apparent to those skilled in the art. Therefore, the scope of the appended claims should be accorded the broadest interpretation so as to encompass all such modifications and similar arrangements.

### Interpretation

Also, it is to be understood that the phraseology and terminology used herein are for the purpose of description and should not be regarded as limiting. The use of “including,” “comprising,” or “having” and variations thereof are meant to encompass the items listed thereafter and equivalents thereof as well as additional items. Unless specified or limited otherwise, the terms “mounted”, “connected”, “supported”, and “coupled” and variations thereof are used broadly and encompass both direct and indirect mountings, connections, supports, and couplings.

In the claims below and the description herein, any one of the terms comprising, comprised of or which comprises is an open term that means including at least the elements/features that follow, but not excluding others. Thus, the term comprising, when used in the claims, should not be interpreted as being limitative to the means or elements or steps listed thereafter. For example, the scope of the expression an apparatus comprising A and B should not be limited to apparatus consisting only of elements A and B. Any one of the terms including or which includes or that includes as used herein is also an open term that also means including at least the elements/features that follow the term, but not excluding others. Thus, including is synonymous with and means comprising.

It should be appreciated that in the above description of example embodiments of the present invention, various features of the present invention are sometimes grouped together in a single example embodiment, FIG., or description thereof for the purpose of streamlining the present invention and aiding in the understanding of one or more of the various inventive aspects. This method of invention, however, is not to be interpreted as reflecting an intention that the claims require more features than are expressly recited in each claim. Rather, as the following claims reflect, inventive aspects lie in less than all features of a single foregoing disclosed example embodiment. Thus, the claims following the Description are hereby expressly incorporated into this Description, with each claim standing on its own as a separate example embodiment of this invention.

Furthermore, while some example embodiments described herein include some but not other features included in other example embodiments, combinations of features of different example embodiments are meant to be within the scope of the present invention, and form different example embodiments, as would be understood by those skilled in the art. For example, in the following claims, any of the claimed example embodiments can be used in any combination.

In the description provided herein, numerous specific details are set forth. However, it is understood that example embodiments of the present invention may be practiced without these specific details. In other instances, well-known methods, structures and techniques have not been shown in detail in order not to obscure an understanding of this description.

Thus, while there has been described what are believed to be the best modes of the present invention, those skilled in the art will recognize that other and further modifications may be made thereto without departing from the spirit of the present invention, and it is intended to claim all such changes and modifications as fall within the scope of the present invention. For example, any formulas given above are merely representative of procedures that may be used. Functionality may be added or deleted from the block diagrams and operations may be interchanged among functional blocks. Steps may be added or deleted to methods described within the scope of the present disclosure.

What is claimed is:

1. An apparatus for protecting a data frame for a frame-based communication link, the apparatus comprising:
a cipher suite module, configured to receive the data frame;
wherein the cipher suite module is further configured to protect the data frame based on a first cryptographic key if the data frame is a priority data frame and protect the data frame based on a second cryptographic key if the data frame is a non-priority data frame, wherein the non-priority data frame is a data frame for which transmission can be interrupted by a data frame that is the priority data frame; and
wherein the cipher suite module is further configured to provide the protected data frame for transmission over the frame-based communication link.

2. The apparatus according to claim 1, wherein protecting the data frame based on the first cryptographic key if the data frame is a priority data frame and protecting the data frame based on the second cryptographic key if the data frame is a non-priority data frame comprises:
adding an integrity value to the data frame using the data frame and the first cryptographic key if the data frame is a priority data frame and adding an integrity value to the data frame using the data frame and the second cryptographic key if the data frame is a non-priority data frame.

3. The apparatus according to claim 2, wherein protecting the data frame based on the first cryptographic key if the data frame is a priority data frame and protecting the data frame based on the second cryptographic key if the data frame is a non-priority data frame further comprises:
encrypting the data frame using the first cryptographic key if the data frame is a priority data frame and encrypting the data frame using the second cryptographic key if the data frame is a non-priority data frame.

4. The apparatus according to claim 1,
wherein the frame-based communication link is a wired communication link.

5. The apparatus according to claim 4,
wherein the frame-based communication link is an Ethernet communication link and the apparatus is a Media Access Control Security, MACsec apparatus of a transmission Ethernet side;
wherein the data frame is an Ethernet data frame, the priority data frame is an express data frame and the non-priority frame is a preemption data frame; and
wherein the first cryptographic key belongs to a first Security Channel, SC, and the second cryptographic key belongs to a second SC.

6. The apparatus according to claim 5,
wherein the cipher suite module is configured to receive the data frame from a transmission queue of a transmission side of the frame-based communication link.

7. The apparatus according to claim 6,
wherein the apparatus further comprises a classification module and an SC configuration module;
wherein the classification module is configured to receive priority information of the data frame from the transmission queue;
wherein the classification module is further configured to classify the data frame based on the priority information as a priority data frame or a non-priority data frame;
wherein the classification module is further configured to provide the classification result to the SC configuration module; and
wherein the SC configuration module is configured to select an SC based on the classification result and to provide the SC to the cipher suite module for protecting the data frame.

8. The apparatus according to claim 4,
wherein providing the protected data frame for transmission comprises providing the protected data frame to an Ethernet MAC module, and wherein the apparatus comprises the Ethernet MAC module or the Ethernet MAC module is connected to the apparatus.

9. An apparatus for verifying a data frame ordering for a frame-based communication link, the apparatus comprising:
a packet number handling module;
wherein the packet number handling module is configured to receive priority information of a received data frame, wherein the priority information indicates whether the received data frame is a priority data frame or a non-priority data frame, and wherein the non-priority data frame is a data frame for which transmission can be interrupted by a data frame that is the priority data frame;
wherein the packet number handling module is further configured to:
receive a packet number of the received data frame; and
if the priority information indicates that the received data frame is a priority frame,
to compare the packet number to a priority packet counter and a common packet counter; and
based on the comparison, to maintain or update the priority packet counter and the common packet counter or to order the discarding of the received data frame; and
if the priority information indicates that the received data frame is a non-priority frame,
to compare the packet number to a non-priority packet counter, the priority packet counter and to the common packet counter; and
based on the comparison, to maintain or update the priority packet counter, the non-priority packet counter and the common packet counter or to order the discarding of the received data frame.

10. The apparatus according to claim 9,
wherein the frame-based communication link is a wired communication link.

11. The apparatus according to claim 10,
wherein the frame-based communication link is an Ethernet communication link and the apparatus is a Media Access Control Security, MACsec apparatus of a receiving Ethernet side; and
wherein the data frame is an Ethernet data frame, the priority data frame is an express data frame and the non-priority data frame is a preemption data frame.

12. The apparatus according to claim 9,
wherein comparing the packet number to a priority packet counter and a common packet counter; and
based on the comparison, maintaining or updating the priority packet counter and to the common packet counter or ordering to discard the received data frame comprises:
if the packet number is equal or greater than the priority packet counter and the common packet counter updating the priority packet counter and the common packet counter,
if the packet number is lower than a lowest packet number of a priority window, starting at the priority packet counter and extending in descending direction, or lower than a lowest packet number of a common window, starting at the common packet counter and extending in descending direction, maintaining the priority packet counter and the common packet counter and ordering to discard the received data frame;
wherein comparing the packet number to a non-priority packet counter, the priority packet counter and to the common packet counter; and
based on the comparison, maintaining or updating the priority packet counter, the non-priority packet counter and the common packet counter or ordering to discard the received data frame comprises:
if the packet number is equal or greater than the non-priority packet counter, the common packet counter or the priority packet counter, updating the priority packet counter, the non-priority packet counter or the common packet counter,
if the packet number is lower than a lowest packet number of a non-priority window, starting at the non-priority packet counter and extending in descending direction or lower than a lowest packet number of the common window, maintaining the priority packet counter,
the non-priority packet counter and the common packet counter and ordering to discard the received data frame.

13. The apparatus according to claim 12,
wherein a size of the priority window and the non-priority windows is zero, and a size of the common window is larger than zero.

14. The apparatus according to claim 11,
wherein the packet number handling module receives the priority information from an Ethernet MAC module, wherein the apparatus comprises the Ethernet MAC module or the Ethernet MAC module is connected to the apparatus.

15. The apparatus according to claim 14,
wherein the apparatus further comprises a decryption module;
wherein the decryption module is configured to decrypt the received data frame when the received data frame is not discarded, wherein the received data frame is received from the Ethernet MAC module and decrypting the received data frame is based on a pre-negotiated security association, SC.

16. The apparatus according to claim 15,
wherein the pre-negotiated SC has been negotiated based on a MACsec Key Agreement, MKA with an Ethernet transmission side.

17. The apparatus according to claim 16,
wherein the pre-negotiated SC consists of a single SC.

18. The apparatus according to claim 15,
wherein the decryption module is further configured to transmit the decrypted received data frame to a receiving queue of the frame-based communication link.

19. A method of performing protection of a data frame with an apparatus according to claim 1.

20. A method of performing verification of a data frame ordering with an apparatus according to claim 9.
